(19) United States
(12) Patent Application Publication
(10) Pub. No.: US 2023/0255197 A1
(43) Pub. Date: Aug. 17, 2023

(54) INFLUENCE OF THE MORPHOLOGICAL AND THE STRUCTURAL CHANGES ON THE ANTIMICROBIAL ACTIVITIES OF TITANATE NANOWIRES

(71) Applicant: BOARD OF TRUSTEES OF THE UNIVERSITY OF ARKANSAS, Little Rock, AR (US)

(72) Inventors: Seaab Sahib, Fayetteville, AR (US); Chenguang Fan, Fayetteville, AR (US); Zheng Ryan Tian, Fayetteville, AR (US)

(21) Appl. No.: 18/109,436

(22) Filed: Feb. 14, 2023

Related U.S. Application Data
(60) Provisional application No. 63/309,691, filed on Feb. 14, 2022.

(51) Int. Cl. A01N 25/08; A01N 37/18

(52) U.S. Cl. CPC A01N 25/08; A01N 37/18

(57) ABSTRACT

The disclosure relates to a method for enhancing antimicrobial effect of an antimicrobial agent. The method includes steps of (1) producing a titanium dioxide (TiO₂) nanowires structure; (2) loading an antimicrobial agent into the TiO₂ nanowires structure; and (3) forming a TiO₂ nanowires - antimicrobial agent complex.

### CROSS-REFERENCE TO RELATED APPLICATION

This application claims priority to and the benefit of U.S. Provisional Pat. Application No. 63/309,691, filed Feb. 14, 2022, which is incorporated by reference herein in its entirety.

### FIELD OF THE INVENTION

This invention relates generally to antimicrobial activities of antimicrobial agent loaded nanostructured titanate and titanium materials.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

The versatile properties of titanium dioxide (TiO₂) nanostructures such as their semiconductivity, piezoelectric property, spontaneous polarization, mechanical, and thermal stability have made these materials very important in many applications such as solid-state lighting, electrical devices manufacturing, skin care product development, and water purification. In one aspect, these nanostructures revealed a novel ability to produce a constant and repeatable electrical current. Piezoelectric materials have shown a great biological effect when they use in bone implants to enhance cells growth. Basically, these materials can interpret the environmental signals into biologically acceptable signals which might positively alter one of the cell pathways and affect growth. Due to this biological use, more interests have been paid for using TiO₂ nanostructures in biotechnological and pharmaceutical industries.

Bacterial resistance, which refers to the capacity of bacteria to withstand the effects of antibiotics or biocides that are designed to kill or control them, is one of the most challenging problems faced by the pharmaceutical industries. Bacteria resistance is accelerated when the presence of antibiotics and antifungals pressure bacteria and fungi to adapt. One major reason leading to the bacterial resistance is overly use of antibiotics. It limits the number of solutions available to fight infections. Therefore, looking for alternative solutions is emergent.

Nanomaterials therefore have been attracting much attention during recent years due to their uses in a variety of biomedical and industrial applications. Most of these uses are based on the ability of these nanostructures to provoke photocatalytic activities, and degradation effects. However, the mechanisms associated with such effects have not been totally illustrated in literatures, while there is a growing interest in developing a nanostructured materials of metal oxide having an enhanced antimicrobial capability.

Therefore, a heretofore unaddressed need exists in the art to address the aforementioned deficiencies and inadequacies.

### SUMMARY OF THE INVENTION

In one aspect, this invention relates to a method for enhancing antimicrobial effect of an antimicrobial agent, the method comprising steps (1) forming a titanium dioxide (TiO₂) nanowires structure; (2) loading an antimicrobial agent into the TiO₂ nanowires structure; and (3) forming a TiO₂ nanowires - antimicrobial agent complex.

In one embodiment, the antimicrobial agent is chloramphenicol. In other embodiment, the antimicrobial agents can be other commonly used antibiotics such as penicillin, amoxicillin, cephalosporins, macrolides, clarithromycin, azithromycin, fluoroquinolones, levofloxacin, ofloxacin, sulfonamides, tetracyclines and aminoglycosides.

In one embodiment, the TiO₂ nanowires structure is formed by TiO₂ nanopowder.

In one embodiment, the method further comprising a step of mixing the TiO₂ nanopowder with a hydroxide solution to form a mixing solution.

In one embodiment, the hydroxide solution comprises at least one of sodium hydroxide solution and potassium hydroxide solution.

In one embodiment, the method further comprising a step of sonicating the mixed solutions.

In one embodiment, the method further comprising a step of heat thermal treating the mixed solutions.

In one embodiment, the method further comprising a step of neutralizing the acidity of the mixed solutions.

In one embodiment, the method further comprising a step of mixing the TiO₂ nanowires structure in a solution with the antimicrobial agents.

In one embodiment, the method further comprising a step of incubating the mixed TiO₂ nanowires structure with the antimicrobial agents in the solution so as to form the TiO₂ nanowires - antimicrobial agent complex.

Another aspect of the invention is directed to an antimicrobial agent loaded metal oxide nanostructure complex, the complex comprising a titanium dioxide (TiO₂) nanowires structure; and an antimicrobial agent loaded to the TiO₂ nanowires structure.

In one embodiment, the antimicrobial agent loaded to the TiO₂ nanowires structure is chloramphenicol.

In one embodiment, the TiO₂ nanowires structure is formed by TiO₂ nanopowder.

In one embodiment, the TiO₂ nanopowder is mixed with a hydroxide solution to form a mixing solution.

In one embodiment, the hydroxide solution comprises at least one of sodium hydroxide solution and potassium hydroxide solution.

In one embodiment, the mixing solution is further sonicated and heated treated.

In one embodiment, the mixing solution is neutralized to reach a pH range between 6.8-7.8.

In one embodiment, the antimicrobial agent is mixed with the TiO₂ nanowires structure.

In one embodiment, the antimicrobial agent loaded to the TiO₂ nanowires structure comprises at least one of Amikacin, Gentamicin, Kanamycin, Neomycin, Netilmicin, Tobramycin, Paromomycin Streptomycin, Spectinomycin, Geldanamycin, Herbimycin, Rifaximin, Loracarbef, Ertapenem, Doripenem, Imipenem/Cilastatin, Meropenem, Cefadroxil, Cefazolin, Cephradine, Cephapirin, Cephalothin, Cefalexin, Cefaclor, Cefoxitin, Cefotetan, Cefamandole, Cefmetazole, Cefonicid, Loracarbef, Cefprozil, Cefuroxime, Cefixime, Cefdinir, Cefditoren, Cefoperazone, Cefpodoxime, Ceftazidime, Ceftibuten, Ceftizoxime, Moxalactam, Ceftriaxone, Cefepime, Ceftaroline fosamil, Ceftobiprole, Teicoplanin, Vancomycin, Telavancin, Dalbavancin, Oritavancin, Clindamycin, Lincomycin, Daptomycin, Azithromycin, Clarithromycin, Erythromycin, Roxithromycin, Telithromycin, Spiramycin, Fidaxomicin, Aztreonam, Furazolidone, Nitrofurantoin, Linezolid, Posizolid, Radezolid, Torezolid, Amoxicillin, Ampicillin, Azlocillin, Dicloxacillin, Flucloxacillin, Mezlocillin, Methicillin, Nafcillin, Oxacillin, Penicillin G, Penicillin V, Piperacillin, Penicillin G, Temocillin, Ticarcillin, Amoxicillin/clavulanate, Ampicillin/sulbactam, Piperacillin/tazobactam, Ticarcillin/clavulanate, Bacitracin, Colistin, Polymyxin B, Ciprofloxacin, Enoxacin, Gatifloxacin, Gemifloxacin, Levofloxacin, Lomefloxacin, Moxifloxacin, Nadifloxacin, Nalidixic acid, Norfloxacin, Ofloxacin, Trovafloxacin, Grepafloxacin, Sparfloxacin, Temafloxacin, Mafenide, Sulfacetamide, Sulfadiazine, Silver sulfadiazine, Sulfadimethoxine, Sulfamethizole, Sulfamethoxazole, Sulfanilimide (archaic), Sulfasalazine Sulfisoxazole, Trimethoprim-Sulfamethoxazole (Co-trimoxazole) (TMP-SMX), Sulfonamidochrysoidine (archaic), Demeclocycline, Doxycycline, Metacycline, Minocycline, Oxytetracycline, Tetracycline, Clofazimine, Dapsone, Capreomycin, Cycloserine, Ethambutol, Ethionamide, Isoniazid, Pyrazinamide, Rifampicin, Rifabutin, Rifapentine, Streptomycin, Arsphenamine, Fosfomycin, Fusidic acid, Metronidazole, Mupirocin, Platensimycin, Quinupristin/Dalfopristin, Thiamphenicol, Tigecycline, Tinidazole, and Trimethoprim.

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings illustrate one or more embodiments of the invention and, together with the written description, serve to explain the principles of the invention. The same reference numbers may be used throughout the drawings to refer to the same or like elements in the embodiments.

FIG. 1 shows a scheme of process for producing TiO₂ nanowires - chloramphenicol complex and verifying its antimicrobial capability.

FIG. 2 shows a chart of evaluation of antimicrobial capabilities of chloramphenicol, TiO₂ nanowires, and TiO₂ nanowires - chloramphenicol Complex, at different concentrations.

FIG. 3 shows the XRD patterns of TiO₂ nanowires prepared.

FIG. 4 shows the EDX spectra of TiO₂ nanowires prepared.

FIG. 5 shows the SEM images of the TiO₂ nanowires prepared.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed may be resorted to by those skilled in the art, and that such modifications and variations are considered to be within the scope of this invention as defined by the appended claims.

Whenever a range is given in the specification, for example, a temperature range, a time range, or a composition or concentration range, all intermediate ranges and subranges, as well as all individual values included in the ranges given are intended to be included in the invention. It will be understood that any subranges or individual values in a range or subrange that are included in the description herein can be excluded from the claims herein.

It will be understood that, as used in the description herein and throughout the claims that follow, the meaning of “a”, “an”, and “the” includes plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element’s relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising”, or “includes” and/or “including”, or “has” and/or “having”, or “carry” and/or “carrying”, or “contain” and/or “containing”, or “involve” and/or “involving”, “characterized by”, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used in the disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in the disclosure, the phrase “at least one of A, B, and C” should be construed to mean a logical (A or B or C), using a non-exclusive logical OR. As used herein, the term “and/or” includes any and all combinations of one or more of the associated listed items.

As used in the disclosure, the phrase “loaded” refers to any type of association of one composition (e.g. an antibiotics) to another composition (e.g. Nanostructured TiO₂ ) or any combination thereof, of this invention. In one embodiment, “loaded” refers to the existence of any type of interaction between the two or more compositions. In one embodiment, the term “loaded” refers to the existence of a hydrogen bond, or in another embodiment, a covalent bond, or in another embodiment, van der Walls interaction, or in another embodiment, π-π interactions between the two compositions. In one embodiment, the term “loaded” refers to any means of association, interaction, bonding or attachment of a composition to or with the foams, films, gels, compositions, or any combination thereof, of this invention, as will be appreciated by one skilled in the art. In one embodiment the term “loaded” refers to any means of association, interaction, bonding or attachment of a composition to a surface of another composition. In one embodiment the term “loaded” refers to any means of association, interaction, bonding or attachment of a composition to an internal structure of another composition.

As used in the disclosure, the term “antibiotics” or “antimicrobial agent” refers to metabolic substances which inhibit or destroy growths of microorganisms, and the term encompasses both naturally occurring and chemically synthesized antibiotic materials.

As used in the disclosure, the terms “nanostructure” or “nanostructures” refers to structures having at least one dimension (e.g., height, length, width, or diameter) of less than 2 micrometers and more preferably less than one micrometer. Nanostructure includes, but is not necessarily limited to, particles and engineered features. The particles and engineered features can have, for example, a regular or irregular shape. Such particles are also referred to as nanoparticles. The term “nanostructured” refers to a material or layer having nanostructures.

As used in the disclosure, the term “nanocarrier” refers to nanomaterial being used as a transport module for another substance, such as a drug.

As used in the disclosure, the term “nanowire” refers to a nanostructure in the form of a wire with the diameter of the order of a nanometre (e.g. 10⁻⁹ metres). Nanowires is defined as structures that have a thickness or diameter constrained to tens of nanometers or less and an unconstrained length.

Embodiments of the invention are illustrated in detail hereinafter with reference to accompanying drawings. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

This disclosure focuses generally on a method for producing a TiO₂ nanowires -antibiotics complex which demonstrates an exceptional antimicrobial activity.

The nanostructured metal oxide materials such SiO₂ and ZnO demonstrates capabilities of drug or molecules entrapment, as well as antimicrobial activities. Among the many metal oxide materials, TiO₂ is remarkable because of its unique antimicrobial activity against gram-positive and negative bacteria. The present invention is directed to TiO₂ nanostructures forming a complex with an antimicrobial agent. In one embodiment, the TiO₂ nanostructures is TiO₂ nanowires. Due to the non-uniform particle sizes of TiO₂ that have been studied previously, the antimicrobial effect might be associated not only with the photocatalytic activity but also with previously-unknown mechanisms that might be related to the size, morphology, and topology of the TiO₂ particle. As such, the present invention shows that, comparing to other TiO₂ nanostructures, TiO₂ nanowires demonstrated a significantly higher efficiency in its antimicrobial bioactivity, especially when the TiO₂ nanowires are loaded with one or more antimicrobial agents.

In determine the efficiency of nanostructures, one effective parameter is the surface area to volume ratio (SA/VOL). This parameter has a great impact on the activity of nanostructures in terms of drug delivery and retention. In particular, smaller nanostructures have a greater SA/VOL which in turn drives loaded drugs or entrapped molecules to be closer to the surface and be released faster. In contrast, larger nanostructures have a smaller SA/VOL which can lead these nanostructures to entrap the drug deeper in the lattice and thereby release it slower. In the present invention, it is discovered that, comparing to other TiO₂ nanostructures, TiO₂ nanowires have an ideal SA/VOL for enhancing the antimicrobial activity of the antimicrobial agent loaded to the TiO₂ nanowires.

One important aspect of the current invention is that the invention minimizes antimicrobial resistance by cutting the administered dosage of the antimicrobial agent to the half or less with the aid of the biocompatible nanostructured titanate and/ortitanium oxide nanowires. In addition, these nanostructures could significantly increase the effect of the antimicrobial drug.

In one embodiment of the present invention, a simple and cost-effective well designed TiO₂ nanostructure is produced for controlling and targeting the release of antimicrobial drug. In one embodiment, the TiO₂ nanowires are being used as a nanocarrier, in which antimicrobial agents are loaded.

The present invention tests the antimicrobial capability of these nanowires as the nanocarriers which is loaded with the antimicrobial agents on the most available pathogens. In one embodiment, chloramphenicol is used as the antimicrobial agents. In one embodiment, E. coli is used as the pathogen. Results of the present invention indicate a promising technology that might help eliminate bacterial resistance and reduce the cost estimated for the therapy

Due to the advantages achieved by the current invention, the rapid increase in bacterial infection and resistance would be reconciled, and the high cost of the therapy would be reduced by the current invention.

### Methods

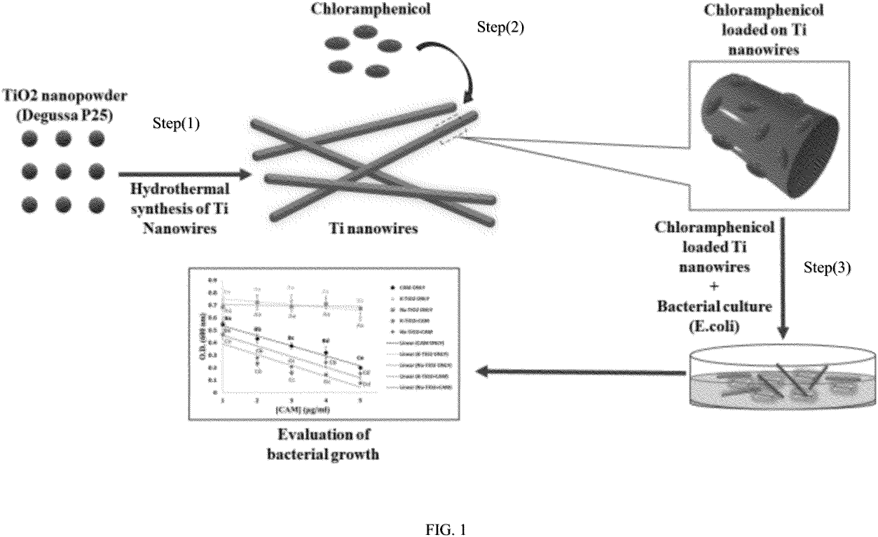

As illustrated in FIG. 1, in step (1), Titanium Dioxide nanopowder (Degussa P25) is used for hydrothermal synthesis of TiO₂ nanowires. In one embodiment, TiO₂ nanopowder is mixed with NaOH solution for a certain period of time. The solution is then sonicated and thermal treated. In one embodiment, the thermal treatment is accomplished by transferring the solution into a stainless steel teflon linear container and sealed well before cooking/heating. In one embodiment, the cooking process includes a step of keeping the solution in an oven at 240° C. for 72 hours. In other embodiments, the mixture solutions may be heated to a temperature between 200-300° C. for a period of 48-96 hours by any type of equipment.

In one embodiment, once the cooking process is done, the solution is washed in DI water for a few times while being vortexed between each wash. In one embodiment, the washing is done with other solutions. After the washing, the resulting materials of TiO₂ nanowires should be naturalized in terms of its acidity such that the pH of the resulting materials should be in a range between 6.8-7.8. In one embodiment, the pH of the resulting materials should be 7.2.

In one embodiment, the NaOH is replace with potassium hydroxide solution. In another embodiment, other hydroxide solutions can be used to replace NaOH.

In step (2) of FIG. 1, an antimicrobial agent is mixed with the TiO₂ nanowires formed in step (1). In one embodiment, chloramphenicol is used as the antimicrobial agent. It should be noted that other antimicrobial agent can be used in the same way as described below. In one embodiment, equal amounts of chloramphenicol were mixed with each sample of the assigned version of nanomaterials (Na-TiO₂ and K-TiO₂) with a w/w ratio of 1:10. In other embodiments, the chloramphenicol was mixed with each sample of the assigned version of nanomaterials (Na-TiO₂ and K-TiO₂) with a w/w ratio of between 1:2 to 1:100.

The mixtures were then rotated gently for 48 hours at room temperature so as to form TiO₂ nanowires - chloramphenicol complex. For comparison purpose, samples of chloramphenicol or nanomaterials alone were also rotated with the same concentrations of corresponding components in the mixture, at the same temperature, and with the same amount of time to serve as controls. In other embodiment, the temperature maintained during the rotation of mixture ranges between 4° C. to 50° C.

In step (3), to test the antimicrobial efficiency, solution of E. coli cells were inoculated into fresh LB medium and incubated at 37° C. overnight. In one embodiment, 5µL solution of E. coli cells was inoculated into 2 ml of fresh LB medium. Sample of the overnight culture was transferred into each well of a 96-well plate and further grown with 200 µL fresh LB medium.

To test antimicrobial activities, different concentrations of antimicrobial agents alone, TiO₂ alone, and TiO₂ nanowires - chloramphenicol complex were added to the LB medium with E. coli cells. It should be noted that same procedure was followed to prepare different concentrations (1, 2, 3, 4, and 5 µg/ml) of either chloramphenicol alone, nanomaterials alone or a mixture of both.

Three identical replicates were prepared on the plate for each assigned material. Then, the 96-well plates were sealed with an oxygen-permeable membrane and the cell growth was monitored by reading the absorbance at 600 nm with microplate readers at 37° C. continuously.

### Example 1

### Nanowires Synthesis

0.375 g portion of Titanium Dioxide nanopowder (Degussa P25) was mixed with 50 ml of 10 molar NaOH solution and left on the magnetic stirrer for 24 hours. Then the obtained solution was sonicated for 15 minutes before the thermal treatment. After sonication, the resulting solution was transferred to a 100 ml stainless steel teflon linear container and sealed well before cooking. The sealed teflon linear container was then cooked in the oven at 240 C for 72 h. After the cooking was done, the obtained suspension was washed with DI water several times alternating between sonication and vertexing for 5 minutes between the washes. Washing process is repeated approximately 20 times until the resulting material becomes neutralized (pH 7.2). This process was followed to prepare the sodium version of titanium dioxide nanowires (Na-TiO₂ nw). The same procedure was performed to obtain the potassium version of the titanium dioxide nanowires with the exception that a 10-molar concentration of potassium hydroxide solution was used instead of sodium hydroxide mentioned previously.

### Drug Loading, Release, Cell Assay

Equal amounts of chloramphenicol were mixed with each sample of the assigned version of nanomaterials (Na-TiO₂ and K-TiO₂) with a w/w ratio of 1:10. The mixtures were rotated gently for 48 hours at room temperature. Samples of chloramphenicol or nanomaterials alone were also rotated with the same concentrations of corresponding components in the mixture, at the same temperature, and with the same amount of time to serve as controls. A 5 µL stock culture of E. coli cells were inoculated into 2 mL of fresh LB medium and incubated at 37° C. overnight. A 5 µL sample of the overnight culture was transferred into each well of a 96-well plate and grown with 200 µL fresh LB medium. To test antimicrobial activities, different concentrations of antimicrobial agents alone, TiO₂ alone, and TiO₂ nanowires - chloramphenicol complex were added to the LB medium with E. coli cells. Same procedure was followed to prepare different concentrations (1, 2, 3, 4, and 5 µg/ml) of either chloramphenicol/ nanomaterials or a mixture of both. Three identical replicates were prepared on the plate for each assigned material. Then, the 96-well plates were sealed with an oxygen-permeable membrane and the cell growth was monitored by reading the absorbance at 600 nm with microplate readers at 37° C. continuously.

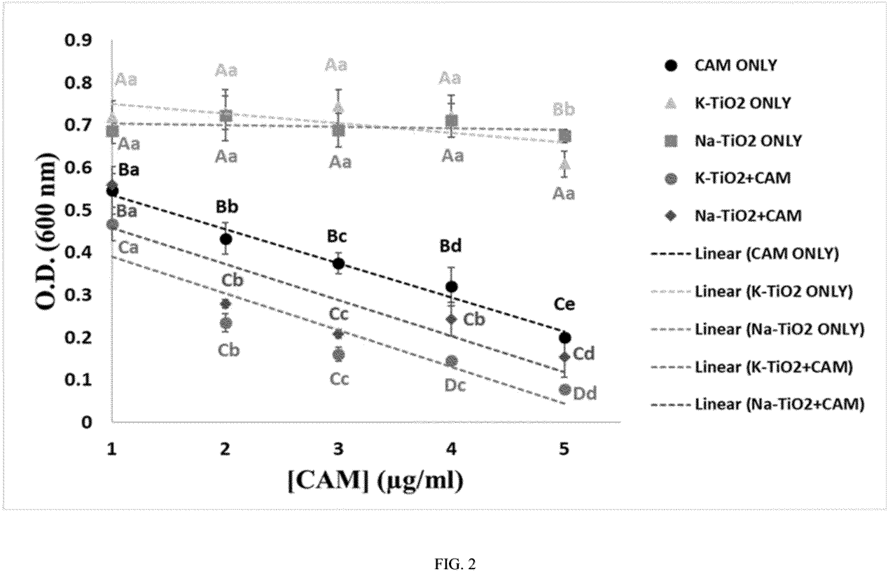

As shown in FIG. 2, the TiO₂ nanowires - chloramphenicol complex demonstrates a significantly better efficiency in terms of antimicrobial effect, as compared to either other TiO₂ nanostructures, or chloramphenicol alone.

In particular, X-axis reflects 5 different concentrations of the chloramphenicol alone, potassium TiO₂ nanowires alone, sodium TiO₂ nanowires alone, potassium TiO₂ nanowires -chloramphenicol complex, and sodium TiO₂ nanowires - chloramphenicol complex; while Y axis reflects the O.D. readings at 600 nm.

As it can be seen from FIG. 2, while the antimicrobial activity of TiO₂ nanowires alone are lower than the antimicrobial activity of chloramphenicol alone, the TiO₂ nanowires-complex, either sodium treated or potassium treated, have antimicrobial activities significantly betterr than that of chloramphenicol alone.

In addition, as illustrated in FIG. 2, to reach certain antimicrobial activity, less amount of antimicrobial agent is needed, when the TiO₂ nanowires-antimicrobial complex is formed. That is, in terms of achieving same degree of antimicrobial effect, as compared to using the antimicrobial agents alone, only a fraction of the antimicrobial agents is necessary if such antimicrobial agents is loaded to the TiO₂ nanowires. For example, at the same O.D. readings 0.25 (same degree of antimicrobial activity), when combining with TiO₂ nanowires, only a concentration of 2 µg/ml for chloramphenicol is necessary, while a concentration of 5 µg/ml for chloramphenicol is necessary when the chloramphenicol is used alone.

### Morphological and Structural Characterization of TiO₂ Nanowaires

Three characterization parameters have been considered in this study (XRD, EDX and SEM imaging). X-ray Diffractometer (XRD, Rigaku MiniFlex II) was used to analyze the phase composition of the as prepared titanate nanowires. The elemental composition of the as prepared samples was characterized using Energy dispersed X-ray diffraction system (EDX) (Bruker AXS Microanalysis GmbH Berlin, Germany). The morphologies of titanate nanowires was obtained using scanning electron microscope (SEM, Tescan VEGA II SBH).

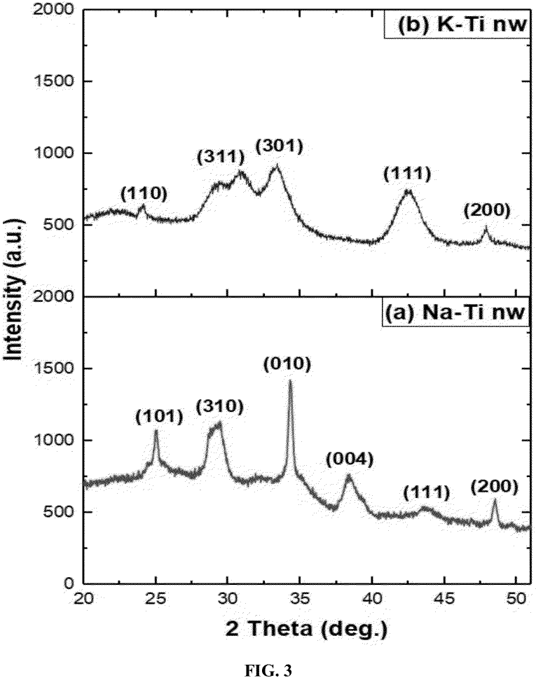

As shown in FIG. 3, the X-ray Powder Diffraction (XRD) patterns of Sodium TiO₂ nanowires (Ti-Na NWs) prepared by the hydrothermal method described above is illustrated on the bottom panel (a), while the potassium TiO₂ nanowires (Ti-K NWs) prepared by the hydrothermal method described above is illustrated on the upper panel (b).

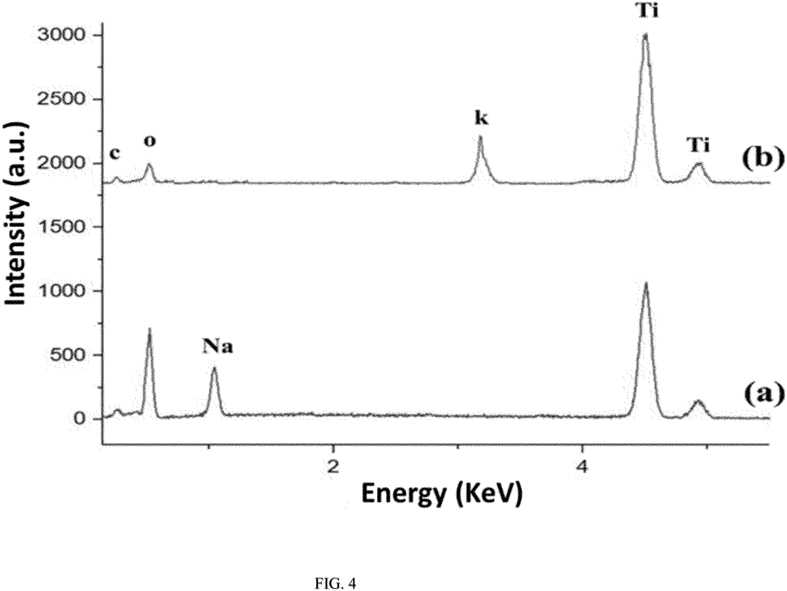

As shown in FIG. 4, the Energy-dispersive X-ray spectroscopy (EDX) spectra of sodium TiO₂ nanowires (Ti-Na NWs) at a particular position on the sample is illustrated in bottom panel (a), and the EDX spectra of potassium TiO₂ nanowires (Ti-K NWs) at a particular position on the sample is illustrated on the upper panel (b).

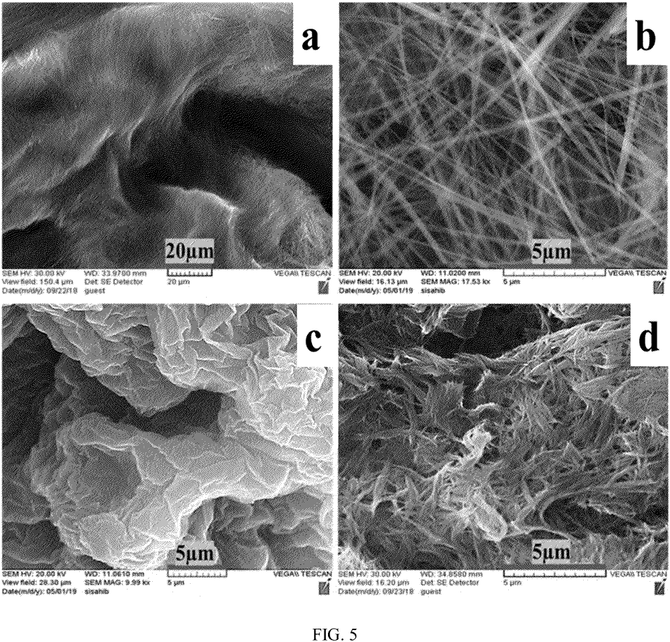

As shown in FIG. 5, the Scanning electron microscope (SEM) images of the as-prepared sodium TiO₂ nanowires (Ti-Na NWs) in are reflected in panel (a) at low magnification and in panel (b) at high magnification. The as-prepared potassium TiO₂ nanowires (Ti-K NWs) are shown in panel (c) at low magnification and in panel (d) at high magnification.

In one embodiment, more than one antibiotics can be loaded to the TiO₂ nanowires.

In other embodiments, instead of Chloramphenicol, other antibiotics can be used in association with the TiO₂ nanowires. These antibiotics include one or more of Amikacin, Gentamicin, Kanamycin, Neomycin, Netilmicin, Tobramycin, Paromomycin Streptomycin, Spectinomycin, Geldanamycin, Herbimycin, Rifaximin, Loracarbef, Ertapenem, Doripenem, Imipenem/Cilastatin, Meropenem, Cefadroxil, Cefazolin, Cephradine, Cephapirin, Cephalothin, Cefalexin, Cefaclor, Cefoxitin, Cefotetan, Cefamandole, Cefmetazole, Cefonicid, Loracarbef, Cefprozil, Cefuroxime, Cefixime, Cefdinir, Cefditoren, Cefoperazone, Cefpodoxime, Ceftazidime, Ceftibuten, Ceftizoxime, Moxalactam, Ceftriaxone, Cefepime, Ceftaroline fosamil, Ceftobiprole, Teicoplanin, Vancomycin, Telavancin, Dalbavancin, Oritavancin, Clindamycin, Lincomycin, Daptomycin, Azithromycin, Clarithromycin, Erythromycin, Roxithromycin, Telithromycin, Spiramycin, Fidaxomicin, Aztreonam, Furazolidone, Nitrofurantoin, Linezolid, Posizolid, Radezolid, Torezolid, Amoxicillin, Ampicillin, Azlocillin, Dicloxacillin, Flucloxacillin, Mezlocillin, Methicillin, Nafcillin, Oxacillin, Penicillin G, Penicillin V, Piperacillin, Penicillin G, Temocillin, Ticarcillin, Amoxicillin/clavulanate, Ampicillin/sulbactam, Piperacillin/tazobactam, Ticarcillin/clavulanate, Bacitracin, Colistin, Polymyxin B, Ciprofloxacin, Enoxacin, Gatifloxacin, Gemifloxacin, Levofloxacin, Lomefloxacin, Moxifloxacin, Nadifloxacin, Nalidixic acid, Norfloxacin, Ofloxacin, Trovafloxacin, Grepafloxacin, Sparfloxacin, Temafloxacin, Mafenide, Sulfacetamide, Sulfadiazine, Silver sulfadiazine, Sulfadimethoxine, Sulfamethizole, Sulfamethoxazole, Sulfanilimide (archaic), Sulfasalazine Sulfisoxazole, Trimethoprim-Sulfamethoxazole (Co-trimoxazole) (TMP-SMX), Sulfonamidochrysoidine (archaic), Demeclocycline, Doxycycline, Metacycline, Minocycline, Oxytetracycline, Tetracycline, Clofazimine, Dapsone, Capreomycin, Cycloserine, Ethambutol, Ethionamide, Isoniazid, Pyrazinamide, Rifampicin, Rifabutin, Rifapentine, Streptomycin, Arsphenamine, Fosfomycin, Fusidic acid, Metronidazole, Mupirocin, Platensimycin, Quinupristin/Dalfopristin, Thiamphenicol, Tigecycline, Tinidazole, and Trimethoprim.

As described above, the present invention provides a method for using TiO₂ nanowires for controlling and targeting the release of an antimicrobial agent. This method is a cheap and effective alternative material to help with the rapid increase in bacterial infections and resistance.

As shown in the present invention, high dosage of antimicrobial drug (chloramphenicol) was required to elicit a significant antimicrobial activity. In contarst, usage of titanate nanowires loaded antimicrobial in the present invention requires a fraction of the antimicrobial drug dosage to elicit a significant antimicrobial activity.

It should also be noted that manipulate the size and the shape of the TiO₂ nanowires produced leads to increase of the entrapment efficiency and control the release pattern of the loaded molecules, namely, antimicrobial agents.

In one embodiment of the invention, the TiO₂ nanowires - antibiotics complex has widely tunable properties, such that the morphology of the nanowires can be adjusted to accommodate any specific needs. In addition, the antimicrobial agents can be specifically selected so as to accommodate any specific needs.

In one embodiment, the TiO₂ nanowires - antibiotics complex is highly stable under different chemical and physical conditions.

In one embodiment, the TiO₂ nanowires - antibiotics complex can be used in water purification process, so as to remove any microbial infection in the water.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### REFERENCE LIST

Damodar, R. A., You, S. J., & Chou, H. H. (2009). Study the self-cleaning, antimicrobial and photocatalytic properties of TiO₂ entrapped PVDF membranes. Journal of hazardous materials, 172(2-3), 1321-1328.

Fu, G., Vary, P. S., & Lin, C. T. (2005). Anatase TiO₂ nanocomposites for antimicrobial coatings. The Journal of Physical Chemistry B, 109(18), 8889-8898.

Kwak, S. Y., Kim, S. H., & Kim, S. S. (2001). Hybrid organic/inorganic reverse osmosis (RO) membrane for bactericidal anti-fouling. 1. Preparation and characterization of TiO₂ nanoparticle self-assembled aromatic polyamide thin-film-composite(TFC) membrane. Environmental science & technology, 35(11), 2388-2394.

Maness, P. C., Smolinski, S., Blake, D. M., Huang, Z., Wolfrum, E. J., & Jacoby, W. A. (1999). Bactericidal activity of photocatalytic TiO₂ reaction: toward an understanding of its killing mechanism. Appl. Environ. Microbiol., 65(9), 4094-4098.

Rincon, A. G., & Pulgarin, C. (2005). Use of coaxial photocatalytic reactor (CAPHORE) in the TiO₂ photo-assisted treatment of mixed E. coli and Bacillus sp. and bacterial community present in wastewater. Catalysis today, 101(3-4), 331-344.

Wei, C., Lin, W. Y., Zainal, Z., Williams, N. E., Zhu, K., Kruzic, A. P., ... & Rajeshwar, K. (1994). Bactericidal activity of TiO₂ photocatalyst in aqueous media: toward a solar- assisted water disinfection system. Environmental science & technology, 28(5), 934-938.

What is claimed is:

1. A method for enhancing antimicrobial effect of an antimicrobial agent, the method comprising:
producing a titanium dioxide (TiO₂) nanowires structure;
loading an antimicrobial agent into the TiO₂ nanowires structure; and
forming a TiO₂ nanowires - antimicrobial agent complex.

2. The method for enhancing antimicrobial effect of an antimicrobial agent of claim 1, wherein:
the antimicrobial agent is chloramphenicol.

3. The method for enhancing antimicrobial effect of an antimicrobial agent of claim 1, wherein:
the TiO₂ nanowires structure is formed by TiO₂ nanopowder.

4. The method for enhancing antimicrobial effect of an antimicrobial agent of claim 3, wherein:
the step of producing the TiO₂ nanowires structure comprises mixing the TiO₂ nanopowder with a hydroxide solution to form a mixing solution.

5. The method for enhancing antimicrobial effect of an antimicrobial agent of claim 4, wherein:
the hydroxide solution comprises at least one of sodium hydroxide solution and potassium hydroxide solution.

6. The method for enhancing antimicrobial effect of an antimicrobial agent of claim 4, wherein the method further comprising:
sonicating the mixed solutions.

7. The method for enhancing antimicrobial effect of an antimicrobial agent of claim 6, wherein the method further comprising:
heat thermal treating the mixed solutions.

8. The method for enhancing antimicrobial effect of an antimicrobial agent of claim 7, wherein the method further comprising:
neutralizing the acidity of the mixed solutions.

9. The method for enhancing antimicrobial effect of an antimicrobial agent of claim 8, wherein the method further comprising:
mixing the TiO₂ nanowires structure in a solution with the antimicrobial agents.

10. The method for enhancing antimicrobial effect of an antimicrobial agent of claim 9, wherein the method further comprising:
incubating the mixed TiO₂ nanowires structure with the antimicrobial agents in the solution so as to form the TiO₂ nanowires - antimicrobial agent complex.

11. An antimicrobial agent loaded metal oxide nanostructure complex, comprising:
a titanium dioxide (TiO₂) nanowires structure; and
an antimicrobial agent loaded to the TiO₂ nanowires structure.

12. The antimicrobial agent loaded metal oxide nanostructure complex according to claim 11, wherein:
the antimicrobial agent loaded to the TiO₂ nanowires structure is chloramphenicol.

13. The antimicrobial agent loaded metal oxide nanostructure complex according to claim 11, wherein:
the TiO₂ nanowires structure is formed by TiO₂ nanopowder.

14. The antimicrobial agent loaded metal oxide nanostructure complex according to claim 13, wherein:
the TiO₂ nanopowder is mixed with a hydroxide solution to form a mixing solution.

15. The antimicrobial agent loaded metal oxide nanostructure complex according to claim 14, wherein:
the hydroxide solution comprises at least one of sodium hydroxide solution and potassium hydroxide solution.

16. The antimicrobial agent loaded metal oxide nanostructure complex according to claim 14, wherein:
the mixing solution is further sonicated and heated treated.

17. The antimicrobial agent loaded metal oxide nanostructure complex according to claim 14, wherein:
the mixing solution is neutralized to reach a pH range between 6.8-7.8.

18. The antimicrobial agent loaded metal oxide nanostructure complex according to claim 13, wherein:
the antimicrobial agent is mixed with the TiO₂ nanowires structure.

19. The method for enhancing antimicrobial effect of an antimicrobial agent of claim 1, wherein:
the antimicrobial agent loaded to the TiO₂ nanowires structure comprises at least one of Amikacin, Gentamicin, Kanamycin, Neomycin, Netilmicin, Tobramycin, Paromomycin Streptomycin, Spectinomycin, Geldanamycin, Herbimycin, Rifaximin, Loracarbef, Ertapenem, Doripenem, Imipenem/Cilastatin, Meropenem, Cefadroxil, Cefazolin, Cephradine, Cephapirin, Cephalothin, Cefalexin, Cefaclor, Cefoxitin, Cefotetan, Cefamandole, Cefmetazole, Cefonicid, Loracarbef, Cefprozil, Cefuroxime, Cefixime, Cefdinir, Cefditoren, Cefoperazone, Cefpodoxime, Ceftazidime, Ceftibuten, Ceftizoxime, Moxalactam, Ceftriaxone, Cefepime, Ceftaroline fosamil, Ceftobiprole, Teicoplanin, Vancomycin, Telavancin, Dalbavancin, Oritavancin, Clindamycin, Lincomycin, Daptomycin, Azithromycin, Clarithromycin, Erythromycin, Roxithromycin, Telithromycin, Spiramycin, Fidaxomicin, Aztreonam, Furazolidone, Nitrofurantoin, Linezolid, Posizolid, Radezolid, Torezolid, Amoxicillin, Ampicillin, Azlocillin, Dicloxacillin, Flucloxacillin, Mezlocillin, Methicillin, Nafcillin, Oxacillin, Penicillin G, Penicillin V, Piperacillin, Penicillin G, Temocillin, Ticarcillin, Amoxicillin/clavulanate, Ampicillin/sulbactam, Piperacillin/tazobactam, Ticarcillin/clavulanate, Bacitracin, Colistin, Polymyxin B, Ciprofloxacin, Enoxacin, Gatifloxacin, Gemifloxacin, Levofloxacin, Lomefloxacin, Moxifloxacin, Nadifloxacin, Nalidixic acid, Norfloxacin, Ofloxacin, Trovafloxacin, Grepafloxacin, Sparfloxacin, Temafloxacin, Mafenide, Sulfacetamide, Sulfadiazine, Silver sulfadiazine, Sulfadimethoxine, Sulfamethizole, Sulfamethoxazole, Sulfanilimide (archaic), Sulfasalazine Sulfisoxazole, Trimethoprim-Sulfamethoxazole (Cotrimoxazole) (TMP-SMX), Sulfonamidochrysoidine (archaic), Demeclocycline, Doxycycline, Metacycline, Minocycline, Oxytetracycline, Tetracycline, Clofazimine, Dapsone, Capreomycin, Cycloserine, Ethambutol, Ethionamide, Isoniazid, Pyrazinamide, Rifampicin, Rifabutin, Rifapentine, Streptomycin, Arsphenamine, Fosfomycin, Fusidic acid, Metronidazole, Mupirocin, Platensimycin, Quinupristin/Dalfopristin, Thiamphenicol, Tigecycline, Tinidazole, and Trimethoprim.

20. The antimicrobial agent loaded metal oxide nanostructure complex according to claim 11, wherein:
the antimicrobial agent loaded to the TiO₂ nanowires structure comprises at least one of Amikacin, Gentamicin, Kanamycin, Neomycin, Netilmicin, Tobramycin, Paromomycin Streptomycin, Spectinomycin, Geldanamycin, Herbimycin, Rifaximin, Loracarbef, Ertapenem, Doripenem, Imipenem/Cilastatin, Meropenem, Cefadroxil, Cefazolin, Cephradine, Cephapirin, Cephalothin, Cefalexin, Cefaclor, Cefoxitin, Cefotetan, Cefamandole, Cefmetazole, Cefonicid, Loracarbef, Cefprozil, Cefuroxime, Cefixime, Cefdinir, Cefditoren, Cefoperazone, Cefpodoxime, Ceftazidime, Ceftibuten, Ceftizoxime, Moxalactam, Ceftriaxone, Cefepime, Ceftaroline fosamil, Ceftobiprole, Teicoplanin, Vancomycin, Telavancin, Dalbavancin, Oritavancin, Clindamycin, Lincomycin, Daptomycin, Azithromycin, Clarithromycin, Erythromycin, Roxithromycin, Telithromycin, Spiramycin, Fidaxomicin, Aztreonam, Furazolidone, Nitrofurantoin, Linezolid, Posizolid, Radezolid, Torezolid, Amoxicillin, Ampicillin, Azlocillin, Dicloxacillin, Flucloxacillin, Mezlocillin, Methicillin, Nafcillin, Oxacillin, Penicillin G, Penicillin V, Piperacillin, Penicillin G, Temocillin, Ticarcillin, Amoxicillin/clavulanate, Ampicillin/sulbactam, Piperacillin/tazobactam, Ticarcillin/clavulanate, Bacitracin, Colistin, Polymyxin B, Ciprofloxacin, Enoxacin, Gatifloxacin, Gemifloxacin, Levofloxacin, Lomefloxacin, Moxifloxacin, Nadifloxacin, Nalidixic acid, Norfloxacin, Ofloxacin, Trovafloxacin, Grepafloxacin, Sparfloxacin, Temafloxacin, Mafenide, Sulfacetamide, Sulfadiazine, Silver sulfadiazine, Sulfadimethoxine, Sulfamethizole, Sulfamethoxazole, Sulfanilimide (archaic), Sulfasalazine Sulfisoxazole, Trimethoprim-Sulfamethoxazole (Cotrimoxazole) (TMP-SMX), Sulfonamidochrysoidine (archaic), Demeclocycline, Doxycycline, Metacycline, Minocycline, Oxytetracycline, Tetracycline, Clofazimine, Dapsone, Capreomycin, Cycloserine, Ethambutol, Ethionamide, Isoniazid, Pyrazinamide, Rifampicin, Rifabutin, Rifapentine, Streptomycin, Arsphenamine, Fosfomycin, Fusidic acid, Metronidazole, Mupirocin, Platensimycin, Quinupristin/Dalfopristin, Thiamphenicol, Tigecycline, Tinidazole, and Trimethoprim.
